(19) United States
(12) Patent Application Publication
(10) Pub. No.: US 2018/0357258 A1
(43) Pub. Date: Dec. 13, 2018

(54) PERSONALIZED SEARCH DEVICE AND METHOD BASED ON PRODUCT IMAGE FEATURES

(71) Applicants: Beijing JingDong ShangKe Information Technology Co., Ltd., Beijing (CN); Beijing Jingdong Century Trading Co., Ltd., Beijing (CN)

(72) Inventors: Ruguo BU, Beijing (CN); Chuan MOU, Beijing (CN)

(21) Appl. No.: 15/579,392

(22) PCT Filed: Apr. 12, 2016
(86) PCT No.: PCT/CN2016/079042

§ 371 Date: Dec. 4, 2017

(30) Foreign Application Priority Data
Jun. 5, 2015 (CN) 201510303163.1

(51) Int. Cl. G06F 17/30; G06N 3/04; G06K 9/46; G06K 9/62; G06F 17/11

(52) U.S. Cl. CPC G06F 17/30256; G06N 3/04; G06F 17/11; G06K 9/623; G06K 9/4642

(57) ABSTRACT

An Embodiment of the present disclosure provides a personalized search device based on product image features, comprising a feature extraction module configured to extract, using a neural network model, an abstract semantic feature vector of an image by category, a category image calculation module configured to calculate a mean and a variance of the abstract semantic feature vector respectively for each dimension, and perform normalization processing, in each dimension, on the abstract semantic feature vector; a user browsing behavior weight calculation module configured to sum the normalized abstract semantic feature vectors extracted by category from all the images browsed by a user, so as to obtain an interest weighting vector of the user for each category; a ranking module configured to get, according to the interest weighting vector of each user for a category, an inner product on feature vectors of images not viewed by the user for the category, so as to obtain a score of each of the images; rank the images according to the obtained scores; and select a predetermined number of images with highest scores for storage; a search invoking module configure to perform a personalized search based on the ranking result of the ranking module.

### CROSS-REFERENCE TO RELATED APPLICATION(S)

This application claims priority to Chinese Application No. 201510303163.1, filed on Jun. 5, 2015, entitled “PERSONALIZED SEARCH DEVICE AND METHOD BASED ON PRODUCT IMAGE FEATURES,” which is incorporated herein by reference in its entirety.

### TECHNICAL FIELD

The present disclosure relates to a personalized search device and method which is based on product image features in the field of electronic commerce.

### BACKGROUND

The existing personalized search method generally performs an extraction of features such as users, products, scene semantics, statistics, and texts, and then obtains a final result according to various search and ranking algorithms. In the existing search method, there is no such a personalized search method that is based on behaviors of users who are browsing product images.

### SUMMARY

The present invention provides a personalized search device and a personalized search method based on product image features, which use a neural network to extract deep abstract semantic feature vectors of product images according to the product images in the field of electronic commerce, classifies browsing behaviors of a user in categories, calculates an interest weight of the user for each category according to the extracted deep abstract semantic feature vectors, and obtains a ranking result of the user for each category according to the interest weight of the user for that category, which is used for a personalized search and thereby improves user experience in multiple dimensions.

The present invention provides a personalized search device based on product image features, comprising:

a feature extraction module configured to extract, using a neural network model, an abstract semantic feature vector of an image by category,

which extracts a Histogram of Oriented Gradient (HOG) feature from the image by graying the image, calculating an gradient of each pixel in the image, dividing the image into 8×8 blocks, calculating a gradient histogram of each block to form a Descriptor of the block, and connecting image blocks of 2×2 blocks in series to obtain 16 chunks, wherein a Descriptor of each chunk is a concatenation of Descriptors of the blocks, and the HOG feature of the whole image is a concatenation of Descriptors of the 16 chunks; and wherein the HOG feature is used as an input signal of a neural network, and an output signal of the neural network output is used as a feature vector of the image;

a category image calculation module configured to receive the abstract semantic feature vector of the image from the feature extraction module, calculate a mean and a variance of the abstract semantic feature vector respectively for each dimension, and perform normalization processing, in each dimension, on the abstract semantic feature vector;

a user browsing behavior weight calculation module configured to sum the normalized abstract semantic feature vectors extracted by category from all the images browsed by a user, so as to obtain an interest weighting vector of the user for each category;

a ranking module configured to get, according to the interest weighting vector of each user for a category from the user browsing behavior weight calculation module, an inner product on feature vectors of images not viewed by the user for the category, so as to obtain a score of each of the images not viewed by the user; rank the images according to the obtained scores; and select a predetermined number of the images with highest scores for storage; and

a search invoking module configure to perform a personalized search based on the ranking result of the ranking module.

The present invention provides a personalized search method based on product image features, comprising:

a feature extracting step of extracting, using a neural network model, an abstract semantic feature vector of an image by category,

a category image calculation step of calculating a mean and a variance of the abstract semantic feature vector respectively for each dimension, and performing normalization processing, in each dimension, on the abstract semantic feature vector;

a user browsing behavior weight calculation step of summing the normalized abstract semantic feature vectors extracted by category from all the images browsed by a user, so as to obtain an interest weighting vector of the user for each category;

a ranking step of getting, according to the interest weighting vector of each user for a category, an inner product on feature vectors of images not viewed by the user for the category, so as to obtain a score of each of the images not viewed by the user; ranking the images according to the obtained scores; and selecting a predetermined number of the images with highest scores for storage; and

a search invoking step of performing a personalized search based on the ranking result of the ranking step.

The Effect of the Invention

The present invention is directed to product images in the field of electronic commerce. The present invention proposes the personalized search according to the browsing behaviors of the user in connection with deep semantic features of the image, thereby improving the user experiences in multiple dimensions.

### BRIEF DESCRIPTION OF THE DRAWINGS

FIG. 1 is a block diagram showing a personalized search device based on product image features according to an embodiment of the present invention.

FIG. 2 is a flowchart showing a product-image-feature-based personalized search method based on product image features according to an embodiment of the present invention.

### DETAILED DESCRIPTION

In order to make the objectives, technical solutions, and advantages of the present invention clearer, the present invention is further described in detail below with reference to the accompanying drawings and the accompanying drawings.

According to the present invention, an abstract semantic feature vector of an image is extracted by using a neural network, a mean and a variance of the feature vectors of all the images for each category in each dimension are calculated, and the extracted feature vectors of images browsed by a user are normalized and summed to obtain the interest weight of the user, which is used for obtaining an inner product on the feature vectors of each image for a category to obtain a score of the image. The scores of the images are ranked and the ranking result is used for a personalized search.

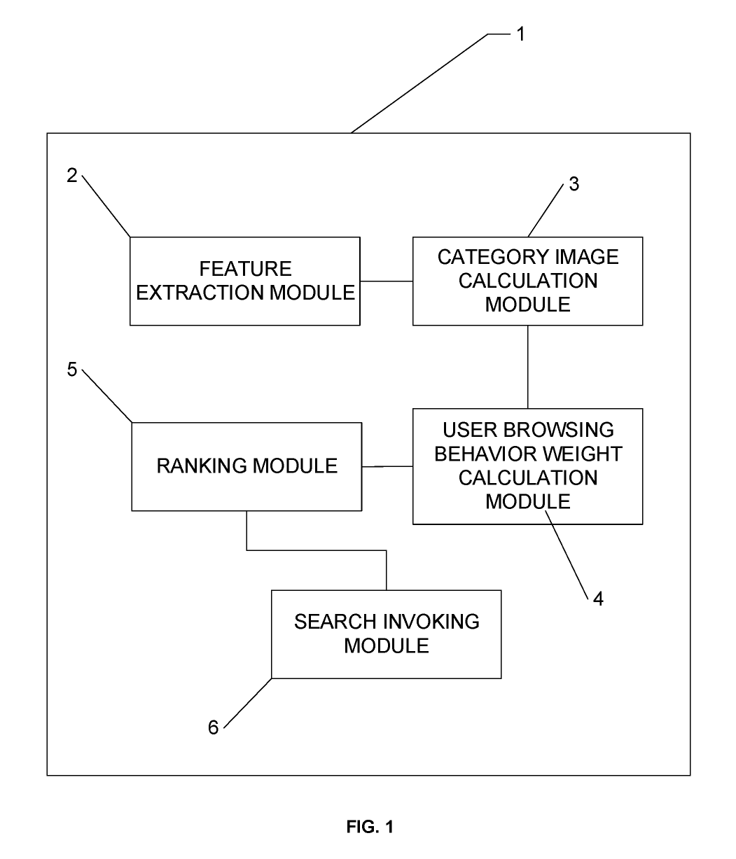

FIG. 1 is a block diagram showing a personalized search device 1 based on product image features according to an embodiment of the present invention.

The personalized search device 1 based on product image features according to the present invention may include a feature extraction module 2, a category image calculation module 3, a user browsing behavior weight calculation module 4, a ranking module 5, and a search invoking module 6.

The feature extraction module 2 is configured to extract, using a neural network model, an abstract semantic feature vector of an image by category, and deliver the abstract semantic feature vector to the category image calculation module 3.

Since the abstract semantic feature vector extracted from the image has a large imbalance in multidimensional distributions, normalization processing is needed on each of the multidimensional distributions in order to avoid influences due to parts of offsets being too large. To this end, the category image calculation module 3 is configured to receive the abstract semantic feature vector of the image delivered from the feature extraction module 2, calculate a mean μᵢ and a variance σᵢ of the abstract semantic feature vector respectively for each dimension, and perform normalization processing, in each dimension, on the abstract semantic feature vector as

$${x}_{i} = \frac{{x}_{i} - {μ}_{i}}{{σ}_{i}} ,$$

wherein i indicates a feature dimension.

The user browsing behavior weight calculation module 4 is configured to remove repetition of the browsing behavior, i.e., taking multiple times of browsing the same image as one browsing behavior, so as to avoid influence of the user's clicking by mistake. Moreover, the user browsing behavior weight calculation module 4 is configured sum the normalized abstract semantic feature vectors extracted by category from all the images browsed by the user, so as to obtain the interest weighting vector of the user for each category, and deliver the obtained interest weighting vector of the user for each category to the ranking module 5.

The ranking module 5 is configured to obtain, according to the interest weighting vector (w₁, w₂, . . . , wₙ) of each user for a category delivered from the user browsing behavior weight calculation module 4, an inner product Σᵢ₌₁ⁿwᵢ·xᵢ on feature vectors of images not viewed by the user for the category, so as to obtain a score of each of the images not viewed by the user, wherein xᵢ indicates a feature vector in the i-th dimension, wᵢ indicates an interest weight in the i-th dimension, and the interest weighting vector (w₁, w₂, . . . , wₙ) indicates an interest weighting vector with n-dimensional interest weights; rank the images according to the obtained scores; and select a predetermined number N of images with highest scores (Top-N) for storage. The above process is repeated for each of all the categories.

The search invoking module 6 may be configured to make a search according to one of the following strategies:

(1) checking a score of an image corresponding to each product in the existing search result, and ranking and outputting the scores in the search result; or

(2) conducting semantic analysis on the user's search item, mapping the user's search item to a category, and taking a product corresponding to a predetermined number N of images having highest scores in that category as the personalized search result.

The personalization search device 1 based on product image features according to the present invention conducts the personalized search according to the browsing behavior of the user in connection with the deep semantic feature of the image, thereby improving the user experiences in multiple dimensions.

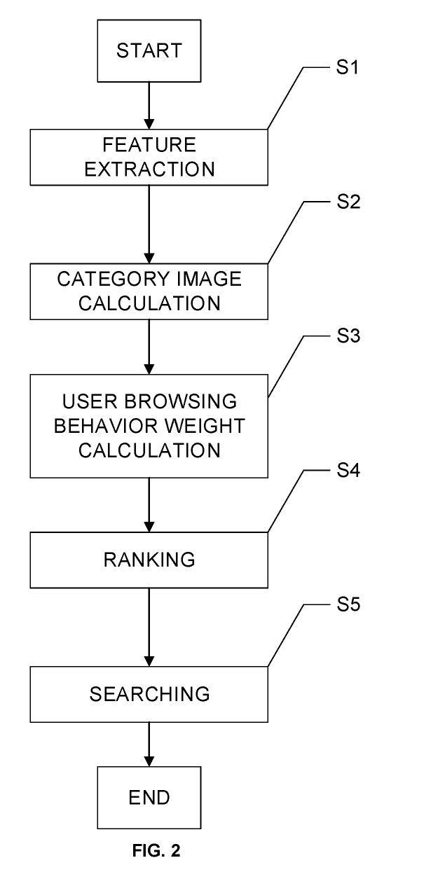

Next, a personalized search method based on product image features according to the present invention will be described with reference to FIG. 2.

FIG. 2 is a flowchart showing a personalized search method based on product image features according to the present invention.

As shown in FIG. 2, a feature extracting step S1 comprises two sub-steps of:

(1) extracting, using a neural network model, an abstract semantic feature vector of an image by category;

(2) delivering the extracted abstract semantic feature vector to a category image calculating step.

Since the abstract semantic feature vector extracted from the image has a large imbalance in multidimensional distributions, normalization processing is needed on each of the multidimensional distributions in order to avoid influences due to parts of offsets being too large.

To this end, the category image calculating step S2 comprises two sub-steps of:

(1) calculating a mean μᵢ and a variance σᵢ of the abstract semantic feature vector respectively for each dimension;

(2) performing normalization processing, in each dimension, on the abstract semantic feature vector as

$${x}_{i} = \frac{{x}_{i} - {μ}_{i}}{{σ}_{i}} ,$$

Next, a user browsing behavior weight calculating step S3 mainly comprises three sub-steps of:

(1) removing repetition of the browsing behavior so as to avoid the influence of the user's clicking by mistake;

(2) summing the normalized abstract semantic feature vectors extracted by category from all the images browsed by the user, so as to obtain the interest weighting vector of the user for each category;

(3) delivering the obtained interest weighting vector of the user for each category to a ranking step.

Next, the ranking step S4 comprises getting, according to the interest weighting vector of each user for a category, an inner product on feature vectors of images not viewed by the user for the category, so as to obtain a score of each of the images not viewed by the user; ranking the obtained scores; and selecting a predetermined number N of images with highest scores for storage. The above process is repeated for each of all the categories.

In a search invoking step S5, it may make a search by one of the following strategies:

(1) checking a score of an image corresponding to each product in the existing search result, and ranking and outputting the scores in the search result;

(2) conducting semantic analysis on the user's search item, mapping the user's search item to a category and taking a product corresponding to a predetermined number N of images having highest scores in that category as the personalized search result.

The personalization search method based on product image features according to the present invention conducts the personalized search according to the browsing behavior of the user in connection with the deep semantic feature of the image, thereby improving the user experiences in multiple dimensions.

In addition, the calculation of interest weight vector will affect the final result. The user browsing cycle and the attenuation of user's desire to purchase a product will also affect the final result.

The objectives, technical solutions and beneficial effects of the present invention are described in further detail in the above specific embodiments. It should be understood that the above is only the specific embodiments of the present invention and not intended to limit the present invention. Any modification, equivalent replacement, improvement and the like made within the spirit and principle of the present invention should be included in the protection scope of the present invention.

1. A personalized search device based on product image features, comprising:
a feature extraction module configured to extract, using a neural network model, an abstract semantic feature vector of an image by category,
wherein the feature extraction module is further configured to extract a Histogram of Oriented Gradient, HOG, feature from the image by graying the image, calculating an gradient of each pixel in the image, dividing the image into 8×8 blocks, calculating a gradient histogram of each block to form a Descriptor of the block, and connecting 2×2 blocks in series to obtain 16 chunks, wherein a Descriptor of each chunk is a concatenation of Descriptors of the blocks, and the HOG feature of the whole image is a concatenation of Descriptors of the 16 chunks; and wherein the HOG feature is used as an input signal of a neural network, and an output signal of the neural network output is used as a feature vector of the image;
a category image calculation module configured to receive the abstract semantic feature vector of the image from the feature extraction module, calculate a mean and a variance of the abstract semantic feature vector respectively for each dimension, and perform normalization processing, in each dimension, on the abstract semantic feature vector;
a user browsing behavior weight calculation module configured to sum the normalized abstract semantic feature vectors extracted by category from all the images browsed by a user, so as to obtain an interest weighting vector of the user for each category;
a ranking module configured to get, according to the interest weighting vector of each user for a category from the user browsing behavior weight calculating module, an inner product on feature vectors of images not viewed by the user for the category, so as to obtain a score of each of the images not viewed by the user; rank the images according to the obtained scores; and select a predetermined number of the images with highest scores for storage; and
a search invoking module configure to perform a personalized search based on the ranking result of the ranking module.

2. The personalized search device based on product image features according to claim 1, wherein the search invoking module is configured to check a score of an image corresponding to each product in the existing search result, and rank and output the scores in the search result.

3. The personalized search device based on product image features according to claim 1, wherein the search invoking module is configured to, after conducting semantic analysis on the user's search item, map the user's search item to a category, and take a product corresponding to a predetermined number of images having highest scores in that category as the personalized search result.

4. The personalized search device based on product image features according to claim 1, wherein assuming that the mean is μᵢ and the variance is σᵢ, the result of the normalization processing is
$${x}_{i} = \frac{{x}_{i} - {μ}_{i}}{{σ}_{i}}$$
wherein i indicates a feature dimension.

5. The personalized search device based on product image features according to claim 1, wherein the user browsing behavior weight calculation module is configured to remove repetition of the browsing behavior.

6. A personalized search method based on product image features, comprising:
a feature extracting step of extracting, using a neural network model, an abstract semantic feature vector of an image by category,
a category image calculation step of calculating a mean and a variance of the abstract semantic feature vector respectively for each dimension, and performing normalization processing, in each dimension, on the abstract semantic feature vector;
a user browsing behavior weight calculation step of summing the normalized abstract semantic feature vectors extracted by category from all the images browsed by a user, so as to obtain an interest weighting vector of the user for each category;
a ranking step of getting, according to the interest weighting vector of each user for a category, an inner product on feature vectors of images not viewed by the user for the category, so as to obtain a score of each of the images not viewed by the user; ranking the images according to the obtained scores; and selecting a predetermined number of the images with highest scores for storage; and
a search invoking step of performing a personalized search based on the ranking result of the ranking step.

7. The personalized search method based on product image features according to claim 6, wherein the search invoking step comprises checking a score of an image corresponding to each product in the existing search result, and ranking and outputting the scores in the search result.

8. The personalized search method based on product image features according to claim 6, wherein the search invoking step comprises conducting semantic analysis on the user's search item, mapping the user's search item to a category, and taking a product corresponding to a predetermined number of images having highest scores in that category as the personalized search result.

9. The personalized search method based on product image features according to claim 6, wherein assuming that the mean is μᵢ and the variance is σᵢ, the result of the normalization processing is
$${x}_{i} = \frac{{x}_{i} - {μ}_{i}}{{σ}_{i}}$$
wherein i indicates a feature dimension.

10. The personalized search method based on product image features according to claim 6, wherein the user browsing behavior weight calculation step comprises removing repetition of the browsing behavior.
